(19) United States
(12) Patent Application Publication
(10) Pub. No.: US 2011/0283481 A1
(43) Pub. Date: Nov. 24, 2011

(54) HINGE BAND FOR DOORS OR WINDOWS

(75) Inventor: Rodney Gene Garrett, Fort Madison, IA (US)

(73) Assignee: KL-Beschlage Karl Loggen GmbH, Eitorf (DE)

(21) Appl. No.: 13/125,225

(22) PCT Filed: Oct. 19, 2009
(86) PCT No.: PCT/IB09/07163

§ 371 Date: Jul. 15, 2011

Related U.S. Application Data
(60) Provisional application No. 61/106,725, filed on Oct. 20, 2008.

(51) Int. Cl. E05D 5/12

(52) U.S. Cl. 16/380

(57) ABSTRACT

The invention concerns a hinge band for doors or windows, which is easy to manufacture, low-cost and comprises an adjusting mechanism for preferred positions. The hinge band is provided with a first band portion and a second band portion, which are connected with one another around a hinge axis in the manner of a hinge. Further, a snap-in locking device arranged within the hinge band is provided. Further, a hinge axis receiving member having a first receiving member for arrangement of the hinge axis and a second hinge axis receiving member having a second receiving member for the arrangement of the hinge axis are provided. The hinge axis is arranged in the first and in the second hinge axis receiving members and comprises, in the area of the first hinge axis receiving member, a recess extending at least partly on the periphery of the hinge axis. The first hinge axis receiving member comprises a first clamping element and a second clamping element. A locking element for movement of the first and the second clamping elements is provided such that the first clamping element and the second clamping element engage with the recess and retain the hinge axis in a clamping fashion.

The invention relates to a hinge band for doors or windows, especially for glass doors.

A hinge band with a snap-in locking device whose snap-in positions are adjustable, is known from EP 0 599 255 A1. In this known hinge band, a rotating body having snap-in recesses is arranged around a hinge axis which connects two band portions in the manner of a hinge. A snap-in body which is received in one of the two band portions engages with these snap-in recesses. Using a clamping mechanism in the form of a clamping screw, accessible from one side of the hinge band, and a pressure body, the rotating body is fixed so that the snap-in positions of the hinge band are adjustable as required.

The above-named hinge band, however, has the disadvantage that it takes a lot of effort and is cost-intensive. In addition, the adjusting possibility for preferred positions (for example an open position or a closed position) implemented in this hinge band is especially inappropriate for small hinge bands because these have hardly any construction space in order to accommodate such a snap-in device.

A further hinge band which can be set to preferred positions is known from WO 2004/085778 A1. This known hinge band comprises a hinge axis in which a snap-in body is supported in the radial direction, thus perpendicular to the rotation axis of the hinge axis, by means of elastic elements. In a snap-in position, the snap-in body engages with a snap-in recess, which is arranged in a sleeve arranged around the hinge axis. Also this adjusting device is not appropriate for somewhat smaller hinge bands, because in this case, too, a large construction space is needed for. Moreover, the known hinge band can only be installed with increased effort, especially due to the described snap-in body.

The invention therefore is based on the task of providing a hinge band that is simple to manufacture, inexpensive, and also comprises an adjusting mechanism for preferred positions, in particular one which is also appropriate for a somewhat smaller hinge band.

This task is, in accordance with the invention, solved with a hinge band with the features of claim 1. Further features of the invention appear from the remaining claims, the following description and/or the annexed Figures.

According to the invention, the hinge band comprises a first band portion as well as a second band portion, wherein the first band portion and the second band portion are connected with one another around a hinge axis in the manner of a hinge. Furthermore, at least one snap-in device arranged inside the hinge band is provided, which snap-in device comprises at least one snap-in body and at least one snap-in recess, wherein in a snap-in position, the snap-in body engages with the snap-in recess. This snap-in position defines a preferred position (for example, an open position or closed position), in which the hinge band is held. In addition, at least one first hinge axis receiving member is provided on the hinge band according to the invention, which receiving member comprises a first receiving member for arranging the hinge axis. In addition, at least one second hinge axis receiving member is provided, which comprises a second receiving member for arranging the hinge axis. The hinge axis is arranged in the first hinge axis receiving member and in the second hinge axis receiving member. Furthermore, the hinge axis comprises, in the area of the first hinge axis receiving member, at least one recess extending at least partly on the periphery of the hinge axis. The first hinge axis receiving member comprises a first clamping element and a second clamping element. In addition, a locking element is provided for movement of the first clamping element and the second clamping element in such a way that the first clamping element and the second clamping element engage with the recess, retaining the hinge axis in a clamping fashion. The locking element assures that the first clamping element and the second clamping element move towards one another in such a way that clamping of the hinge axis is assured.

The invention ensures that a preferred position of the hinge band can be set by rotating the hinge axis accordingly. This preferred position is then fixed by clamping the hinge axis using the first clamping element and the second clamp element, due to these engaging with the recess thanks to the locking element and retaining the hinge axis in a clamping fashion. Such a construction is especially appropriate for small hinge bands, because only a small construction space is required. Furthermore, the invention allows for an inexpensive and simple manufacturing as well as installation.

In one embodiment of the hinge band according to the invention, both the first hinge axis receiving member and the second hinge axis receiving member are arranged on the first band portion or the second band portion. For example, the first hinge axis receiving member and the second hinge axis receiving member may be constructed as essentially rectangular components, which are attached to the first band portion or the second band portion, for example using a screw connection.

In a further embodiment of the hinge band according to the invention, it is intended for the hinge axis to be provided with a first end and a second end. The first end of the hinge axis is arranged in the first hinge axis receiving member. On the contrary, the second end of the hinge axis is arranged in the second hinge axis receiving member. Further, it may, for example, be intended to arrange the recess on the first end of the hinge axis.

In yet another embodiment of the hinge band according to the invention, the recess extends along the full periphery of the hinge axis. For example, the recess is constructed as a groove which extends on the full periphery of the hinge axis. Such construction and arrangement of the recess are advantageous because these are particularly easy to manufacture.

In an embodiment of the hinge band according to the invention, it is further intended for the first hinge axis receiving member to comprise a recess which is next to the first receiving member. In the recess, both the first clamping element and the second clamping element are arranged. For example, the recess can be constructed as a blind hole. In addition, in a further embodiment of the hinge band, it is intended for the recess to comprise a wall on which the second clamping element is arranged. The first clamping element engages with the recess from a first side of the recess. On the contrary, the second clamping element engages with the second recess from a second side of the recess from the direction of the wall. The first side and the second side lie opposite one another. In this way it can be ensured that the hinge axis is retained especially well by the first clamping element and the second clamping element in a clamping fashion.

In an alternative embodiment of the hinge band according to the invention, the recess is constructed as a passage opening. In this embodiment, the first hinge axis receiving member is arranged on the first band portion (or the second band portion) such that the second clamping element is arranged resting against the first band portion (or second band portion). On clamping the hinge axis, during which the first clamping element and the second clamping element move relatively towards one another, it is however possible that the second clamping element moves away from the first band portion (or second band portion).

In a further embodiment of the hinge band according to the invention, the first clamping element is provided with a passage bore. On the contrary, the second clamping element is provided with a first thread. The locking element is furthermore provided with a second thread which can engage with the first thread of the second clamping element. By introducing the locking element into the passage bore of the first clamping element and subsequently screwing the locking element into the second clamping element, this embodiment will ensure that the first clamping element and the second clamping element move towards one another in such a way that the hinge axis will be retained clamped between them. In a further embodiment of the hinge band, it is further intended for the first clamping element and/or the second clamping element to comprise a conically tapering surface, which is meant to engage with the recess. A conically tapering surface (for example at an angle of 60 deg.) is particularly appropriate to create a clamping effect.

In yet another embodiment of the hinge band according to the invention, the hinge axis is provided with the snap-in recess. On the contrary, the snap-in body is moveably guided in the first band portion or in the second band portion. For example, the snap-in body is moveably guided in the first band portion against the effect of a return element (for example, a spring element). The return element comprises a first end and a second end, wherein the first end rests against the snap-in body or against a snap-in body connecting element arranged on the snap-in body. The second end rests against an adjusting element with which a return force of the return element can be adjusted. In this way, it is possible to adjust the force with which the snap-in body is pressed into the snap-in recess.

Following, the invention is described in greater detail on the basis of an embodiment with the help of figures. These show the following:

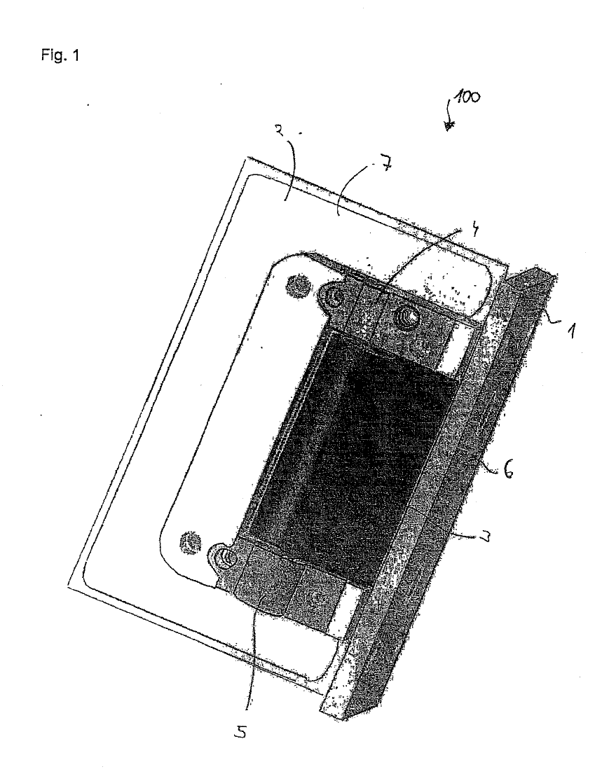

FIG. 1 a schematic representation of a hinge band according to the invention;

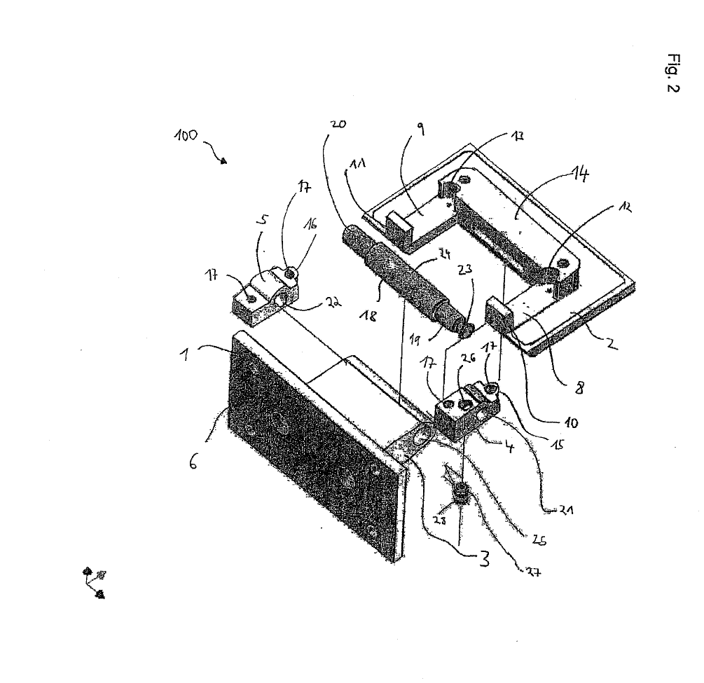

FIG. 2 an exploded view of the hinge band according to FIG. 1; and

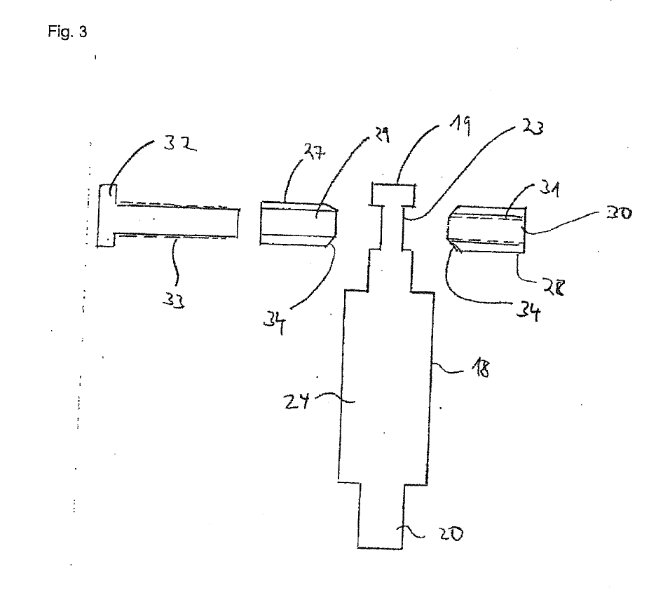

FIG. 3 a schematic representation of a hinge axis with a first clamping element and with a second clamping element.

FIG. 1 shows a schematic representation of a hinge band 100, which is provided with a first band portion 1 and with a second band portion 2. The hinge band 100 shown here is constructed as a “glass-wall” hinge band, which is intended for the attachment of a glass door to a building wall. it is, however, explicitly pointed out—at this stage already—that the invention is not limited to a “glass-wall” hinge band. Rather, the invention can be used for any hinge band, especially with a so-called “glass-glass” hinge band, which connects a glass door with a glass pane.

The first band portion 1 is intended for attachment to a building wall. It shows a screw plate 6, which is provided with passage holes. In the passage holes, attachment means can be received with which the screw plate 6 and therefore the hinge band 100 can be attached to a house wall. The first band portion 1 is further provided with a hinge axis block 3, which is attached to the screw plate 6. The hinge axis block 3 serves to receive a hinge axis, as is shown in more detail further below.

The second band portion 2 is shown without a cover, so that a view into the hinge band 100 is possible. Between a first clamping plate 7 and a second clamping plate (not shown), glass of a glass door is clamped. Furthermore, on the second band portion 2, a first hinge axis receiving member 4 and a second hinge axis receiving member 5 are arranged each of which receives one end of a hinge axis. This is also explained in more detail further below.

FIG. 2 shows an exploded view of the hinge band 100. On the second band portion 2, an engaging block 14 is arranged which will be arranged in a section of the glass door. The engaging block 14 shows a first recess 8, which is limited on a first side by a first bar 10, and on a second side by a first guiding element 12. The engaging block 14 further comprises a second recess 9, which is limited on the first side by a second bar 11 and on a second side by a second guiding element 13. Both the first guiding element 12 and the second guiding element 13 have a semicircular contour.

The first hinge axis receiving member 4 is arranged in the first recess 8. The first hinge axis receiving member 4 comprises a third guiding element 15, which engages with the first guiding element 12 on the second band portion 2. Furthermore the first hinge axis receiving member 4 is provided with bore holes 17, in which attachment means (not shown) are arranged, in order to arrange the first hinge axis receiving member 4 on the second band portion 2.

The second hinge axis receiving member 5 is arranged on the second band portion 2 in a very similar fashion. Thus, the second hinge axis receiving member 5 comprises a fourth guiding element 16, which engages with the second guiding element 13 on the second band portion 2. Furthermore the second hinge axis receiving member 5 is provided with bore holes 17 in which attachment means (not shown) are arranged in order to arrange the second hinge axis receiving member 5 on the second band portion 2.

The hinge axis, already mentioned above, is designated with the reference sign 18. It comprises a first end 19, a second end 20 as well as a basis area 24 arranged between the first end 19 and the second end 20. The first end 19 of the hinge axis 18 is provided with a recess 23 which is constructed as a groove extending on the whole periphery of the hinge axis 18. The first end 19 of the hinge axis 18 is arranged in the first receiving member 21 of the first hinge axis receiving member 4. On the contrary, the second end 20 of the hinge axis 18 is arranged in the second receiving member 22 of the second hinge axis receiving member 5. The basis area 24, in turn, is moveably guided in a passage bore 25 of the hinge axis block 3 around the longitudinal axis (rotation axis) of the hinge axis 18.

In the first hinge axis receiving member 4, a third recess 26 is arranged which is adjacent to the first receiving member 21. In other words, the first receiving member 21 is accessible from the third recess 26. In the first recess 26, a first clamping element 27 and a second clamping element 28 are arranged, wherein the second clamping element 28 is adjacent to the wall of the first recess 8 upon assembly of the hinge band 100. As shown, the third recess 26 is somewhat displaced with respect to the first receiving member 21, so that the first clamping element 27 and the second clamping element 28 are arranged somewhat sideways with respect to the hinge axis 18.

A schematic representation of the arrangement of the hinge axis 100, the first clamping element 27 and the second clamping element 28 is represented schematically in FIG. 3. The first clamping element 27 is guided from a first side into the recess 23 of the hinge axis 18. On the contrary, the second clamping element 28 is guided from a second side to the recess 23 of the hinge axis 18. The first side and the second side lay opposite one another. The second side is arranged in the area of the wall of the first recess 8. The first clamping element 27 is provided with a first clamping bore 29. The second clamping element 28 is provided with a second clamping bore 30, which comprises a first thread 31 in an internally-threaded form. Furthermore, both the first clamping element 27 and the second clamping element 28 are provided with a conical clamping surface 34, each of which is intended for engaging with the recess 23 of the hinge axis 18.

In FIG. 3, furthermore, a locking element 32 is shown which comprises a section with a second thread 33 in an externally-threaded form. In order to clamp and fix the position of the hinge axis 18, the locking element 32 is guided through the first clamping bore 29 and into the second clamping bore 30, so that the first thread 31 engages with the second thread 33. By screwing in the lock element 32 into the second clamping element 28, both the first clamping element 27 and the second clamping element 28 are moved in the direction of the hinge axis 18 in such a way that both the first clamping element 27 and the second clamping element 28 come to rest with their conical clamping surfaces 34 in the recess 23. The hinge axis 18 is clamped between the first clamping element 27 and the second clamping element 28.

The invention ensures that a preferred position of the hinge band 100 can be adjusted by rotating the hinge axis 18 accordingly. This preferred position is then fixed by clamping the hinge axis 18 using the first clamping element 27 and the second clamping element 28, due to these engaging with the recess 23 due to the locking element 32 and retaining the hinge axis 18 clamped. Such a construction is especially appropriate for small hinge bands, because only a small building space is required. Furthermore, the invention allows for an inexpensive and simple manufacturing and installation.

The preferred position is set by a snap-in locking device. This comprises a snap-in recess which is arranged along the longitudinal axis of the hinge axis 18 on the outside surface of the hinge axis 18. In addition, the snap-in locking device comprises a snap-in body that is arranged in the hinge axis block 3 of the first band portion 1. The snap-in body is moveably guided in the first band portion 1 against the effect of a return element (for example, a spring element). The return element comprises a first end and a second end, wherein the first end rests against the snap-in body or against a snap-in body connecting element arranged on the snap-in body. The second end rests against an adjusting element with which a return force of the return element can be adjusted. In this way it is possible to adjust the force with which the snap-in body is pressed into the snap-in recess.

### LIST OF REFERENCE SIGNS

1 first band portion

2 second band portion

3 hinge axis block

4 first hinge axis receiving member

5 second hinge axis receiving member

6 screw plate

7 first clamping plate

8 first recess

9 second recess

10 first bar

11 second bar

12 first guiding element

13 second guiding element

14 engaging block

15 third guiding element

16 fourth guiding element

17 bore hole

18 hinge axis

19 first end of the hinge axis

20 second end of the hinge axis

21 first receiving member

22 second receiving member

23 recess

24 basis area

25 passage bore

26 third recess

27 first clamping element

28 second clamping element

29 first clamping bore

30 second clamping bore

31 first thread

32 locking element

33 second thread

34 conical clamping surface

100 hinge band

1-10. (canceled)

11. A hinge band for doors or windows comprising:
a first band portion;
a second band portion, wherein the first band portion and the second band portion are connected with one another around a hinge axis in the manner of a hinge;
at least one snap-in locking device arranged within the hinge band, which comprises at least one snap-in body and at least one snap-in recess, wherein in a snap-in position, the snap-in body engages with the snap-in recess;
at least one first hinge axis receiving member which comprises a first receiving member for arrangement of the hinge axis, and with at least a second hinge axis receiving member which comprises a second receiving member for the arrangement of the hinge axis;
wherein:
the hinge axis is arranged in the first hinge axis receiving member and in the second hinge axis receiving member;
the hinge axis comprises, in the area of the first hinge axis receiving member, at least one recess extending at least partly on the periphery of the hinge axis;
the first hinge axis receiving member comprises a first clamping element and a second clamping element; and
a locking element is intended for movement of the first clamping element and the second clamping element in such a way that the first clamping element and the second clamping element engage with the recess and retain the hinge axis in a clamping fashion.

12. The hinge band of claim 11, wherein both the first hinge axis receiving member and the second hinge axis receiving member are arranged on the first band portion or on the second band portion.

13. The hinge band of claim 11, wherein:
the hinge axis comprises a first end and a second end;
the first end of the hinge axis is arranged in the first hinge axis receiving member; and
the second end of the hinge axis is arranged in the second hinge axis receiving member.

14. The hinge band of claim 12, wherein:
the hinge axis comprises a first end and a second end;
the first end of the hinge axis is arranged in the first hinge axis receiving member; and
the second end of the hinge axis is arranged in the second hinge axis receiving member.

15. The hinge band of claim 13, wherein on the first end of the hinge axis, the recess is arranged.

16. The hinge band of claim 11, wherein the recess extends on the entire periphery of the hinge axis.

17. The hinge band of claim 11, wherein the first hinge band receiving member comprises a recess, which is adjacent to the first receiving member, wherein in the recess both the first clamping element and the second clamping element are arranged.

18. The hinge band of claim 17, wherein:
the recess comprises a wall on which the second clamping element is arranged;
the first clamping element engages with the recess from the first side of the recess;
the second clamping element engages with the second recess from a second side of the recess from the direction of the wall; and
the first side and the second side lie opposite one another.

19. The hinge band of claim 11, wherein the first clamping element is provided with a passage bore and wherein the second clamping element is provided with a thread.

20. The hinge band of claim 11, wherein one of the first clamping element and the second clamping comprises a conically tapering surface, which is intended for engaging with the recess.

21. The hinge band of claim 11, wherein the first clamping element and the second clamping element comprise a conically tapering surface, which is intended for engaging with the recess.

22. The hinge band of claim 11, wherein the hinge axis is provided with the snap-in recess and wherein the snap-in body is moveably guided in the first band portion or into the second band portion.
